(19) United States
(12) Patent Application Publication
(10) Pub. No.: US 2011/0176874 A1
(43) Pub. Date: Jul. 21, 2011

(54) Coiled Tubing Compensation System

(75) Inventor: Galen Hebert, Breaux Bridge, LA (US)

(73) Assignee: Halliburton Energy Services, Inc.

(21) Appl. No.: 12/689,989

(22) Filed: Jan. 19, 2010

(51) Int. Cl. E21B 19/22; B65H 75/44; F16L 1/12

(52) U.S. Cl. 405/158; 242/390; 166/77.2; 166/335

(57) ABSTRACT

A tubing sheave apparatus is disclosed. A circular member has a grooved circumference. A hub is coupled to the circular member via one or more radial support members. The circular member and the hub have a rotational axis. A roller is disposed near the grooved circumference. An actuator is coupled to the roller and configured to move the roller at least toward the grooved circumference. The roller and the grooved circumference are configured to contact tubing disposed therebetween.

### BACKGROUND

The present disclosure relates to use of coiled tubing in the oil industry, and, more particularly, to a coiled tubing compensation system.

Coiled tubing may be introduced into an oil or gas well bore through wellhead control equipment to perform various tasks during the exploration, drilling, production, and workover of the well. Coiled tubing may be used, for example, to inject gas or other fluids into the well bore, to inflate or activate bridges and packers, to transport tools downhole such as logging tools, to perform remedial cementing and clean-out operations in the bore, to deliver drilling tools downhole, for electric wireline logging and perforating, drilling, wellbore cleanout, fishing, setting and retrieving tools, for displacing fluids, and for transmitting hydraulic power into the well.

Coiled tubing generally includes a cylindrical tubing made of metal or composite that has a relatively thin cross sectional thickness. The continuous length of coiled tubing is a sufficiently flexible and ductile product such that it may curved for storage on a drum or reel. The product is typically several thousand feet long.

Coiled tubing is often used for offshore hydrocarbon drilling and producing operations. Offshore operations are typically conducted from a drilling rig located either on a bottom-founded offshore platform or on a floating platform. A floating platform is a ship, vessel, or other structure, such as a tension-leg platform, for example, in which the weight of the platform is supported by water buoyancy.

Typical offshore applications using coiled tubing have a number of drawbacks. Coiled tubing typically must be spooled off a reel and manually connected to a crane or winch to support the weight of the conduit. Coiled tubing applications may be typically limited to specialized vessels, such as drill-ships. A reel of coiled tubing mounted on a vessel—especially a relatively smaller, lighter vessel—is subject to movement due to the heave of the vessel with the swells of the sea. When the coiled tubing is deployed to extend from the proximity of the sea surface toward equipment on the sea floor, keeping the coiled tubing straight is desirable. Such movement may also cause movement of the coiled tubing. Because the coiled tubing is not kept under tension in that situation, potential exists for compression and slackening and, in turn, buckling, overextension or failure on the subsea injector or well head components.

### SUMMARY

The present disclosure relates to use of coiled tubing in the oil industry, and, more particularly, to a coiled tubing compensation system.

In one aspect, a tubing sheave apparatus is disclosed. A circular member has a grooved circumference. A hub is coupled to the circular member via one or more radial support members. The circular member and the hub have a rotational axis. A roller is disposed near the grooved circumference. An actuator is coupled to the roller and configured to move the roller at least toward the grooved circumference. The roller and the grooved circumference are configured to contact tubing disposed therebetween.

In another aspect, a coiled tubing system is disclosed. A sheave is adapted for coiled tubing and including a grooved rim. A roller assembly is coupled to the sheave and adapted to cooperate with the grooved rim to apply forces to coiled tubing. A boom section is coupled to the sheave. A reel assembly frame is coupled to the boom section. A reel assembly is coupled to the reel assembly frame. An actuator is coupled between the reel assembly frame and the boom section. The actuator is operable to move the boom section relative to the reel assembly frame. The boom section and the sheave are configured to cooperatively adjust based on vertical forces applied to the reel assembly frame.

In yet another aspect, a method of deploying coiled tubing from a seagoing vessel is disclosed. The method includes lowering coiled tubing into a body of water with a coiled tubing system. The coiled tubing system includes a sheave adapted for coiled tubing and including a grooved rim. A roller assembly is coupled to the sheave and adapted to cooperate with the grooved rim to apply forces to coiled tubing. A boom section is coupled to the sheave. A reel assembly frame is coupled to the boom section. A reel assembly is coupled to the reel assembly frame. An actuator is coupled between the reel assembly frame and the boom section. The actuator is operable to move the boom section relative to the reel assembly frame. The method further includes adjusting the boom section and the sheave based on vertical forces applied to the reel assembly frame.

The features and advantages of the present disclosure will be readily apparent to those skilled in the art. While numerous changes may be made by those skilled in the art, such changes are within the spirit of the invention.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features.

FIG. 1 is a schematic of a coiled tubing system in one exemplary operating environment in accordance with certain embodiments of the present disclosure.

FIG. 2A shows a schematic of a broadside view of a sheave apparatus in accordance with certain embodiments of the present disclosure.

FIG. 2B shows a schematic of an inline cross-sectional view of a sheave apparatus in accordance with certain embodiments of the present disclosure.

FIG. 3A shows a schematic of a broadside view of a sheave apparatus with a tension apparatus in accordance with certain embodiments of the present disclosure.

FIG. 3B shows a schematic of an inline cross-sectional view of a sheave apparatus with a tension apparatus in accordance with certain embodiments of the present disclosure.

FIG. 3C shows a schematic of a partial inline cross-sectional view of a sheave apparatus with a tension apparatus in accordance with certain embodiments of the present disclosure.

FIG. 3D shows a schematic of a partial perspective view of a sheave apparatus with a tension apparatus in accordance with certain embodiments of the present disclosure.

FIGS. 4A and 4B show a schematic of a side view of a coiled tubing system in accordance with certain embodiments of the present disclosure.

FIG. 5A shows a schematic of a top view of a mast boom and sheave apparatus in accordance with certain embodiments of the present disclosure.

FIG. 5B shows a schematic of a side view of a mast boom in accordance with certain embodiments of the present disclosure.

### DESCRIPTION OF PREFERRED EMBODIMENTS

The present disclosure relates to use of coiled tubing in the oil industry, and, more particularly, to a coiled tubing compensation system.

Illustrative embodiments of the present disclosure are described in detail herein. In the interest of clarity, not all features of an actual implementation are described in this specification. It will of course be appreciated that in the development of any such actual embodiment, numerous implementation-specific decisions must be made to achieve developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of the present disclosure.

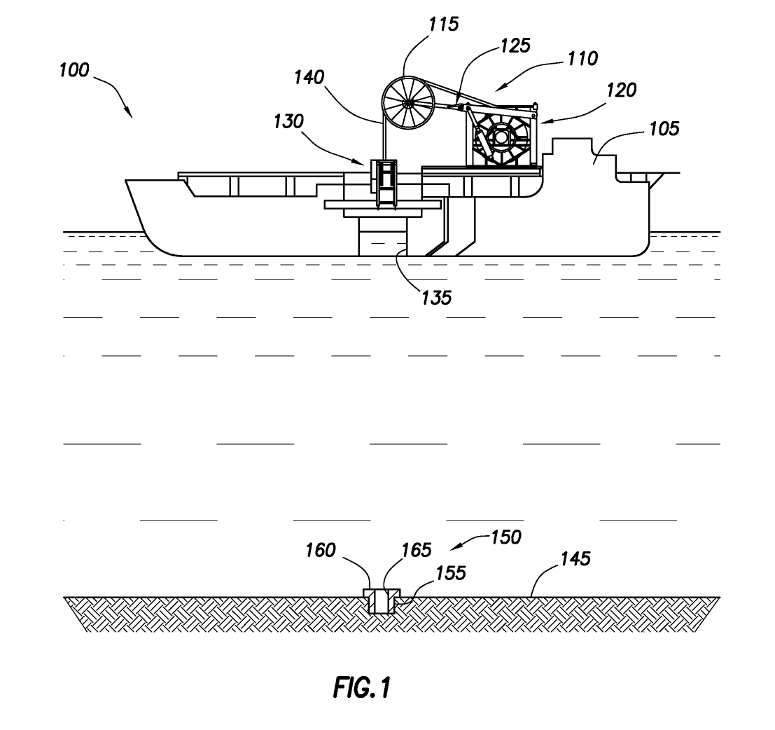

FIG. 1 shows one exemplary operating environment for certain embodiments in accordance with the present disclosure. FIG. 1 represents a deepwater well where the present disclosure may be particularly advantageous. An offshore floating platform 100 comprises a floating vessel 105 having a coiled tubing system 110 with a circular sheave 115, a reel assembly 120, and a boom section 125. FIG. 1 depicts a subsea injector 130 suspended over a moonpool 135. The subsea injector 130 may be configured to receive, direct and feed coiled tubing 140 from the sheave 115 and reel assembly 120. The subsea injector 130 may be lowered toward through the moonpool 425 toward the seafloor 145.

In FIG. 1, the floating platform 100 is shown situated adjacent a subsea wellsite 150, which may include a structural casing 155 and a wellhead housing 160. The subsea injector 130 may be mounted above wellhead housing 160, and may be aligned along an axis of the wellbore 165. Once the injector 130 is positioned, the injector 130 may feed and direct coiled tubing 140 from the sheave 115 to the wellbore 165.

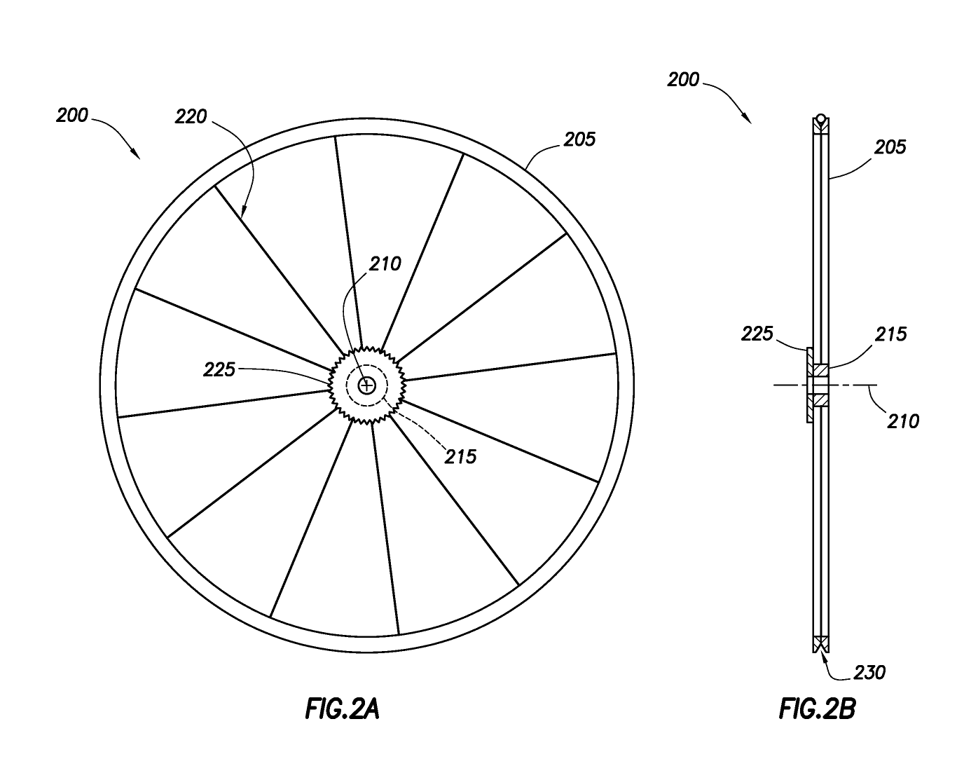

FIGS. 2A and 2B respectively show schematics of broadside and inline perspectives of a circular sheave apparatus 200. The circular sheave apparatus 200 may include a center axis 210 about which the circular sheave 200 may rotate. The circular sheave 200 may include a circular member 205 coupled to a hub 215 via a plurality of radial supports 220. The circular member 205 may be capable of supporting loads from its circumference and of transferring loads toward the center of the sheave 200. Such loads may be induced by the weight of coiled tubing and other equipment attached thereto. The sheave 200 may have a gear apparatus 225 mounted to one side to be driven by a power source (not shown). Accordingly, force may be applied to the sheave 200, and thereby to coiled tubing about its circumference, in order to suspend or rotate sheave 200 in either direction.

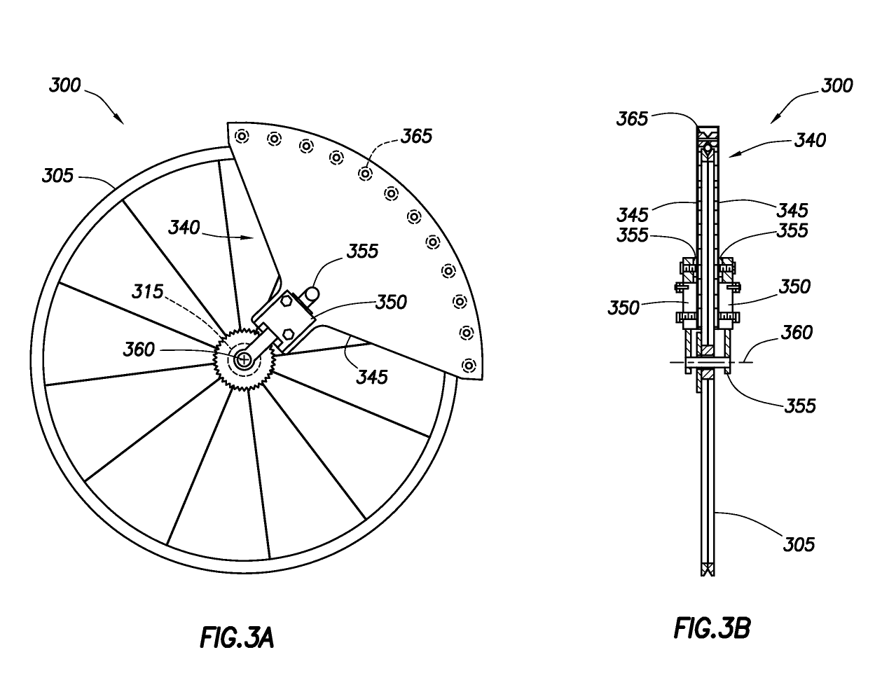

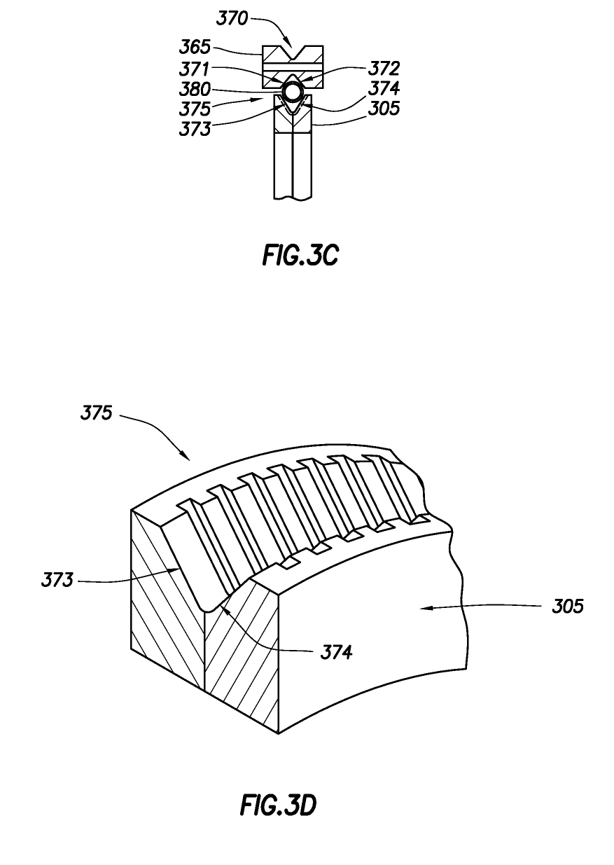

FIGS. 3A and 3B respectively show schematics of broadside and inline views of a sheave 300 with a tension apparatus 340. The tension apparatus 340 may include tension plates 345 disposed alongside circular member 305, with one tension plate on each side of circular member 305. Although two tension plates are depicted, alternative embodiments may employment only one tension plate. As shown in FIG. 3A, tension plates 345 may generally span an arc about the circumference of circular member 305. Each tension plate 345 may form a solid plate as shown, but alternative embodiments may include varying forms of tension members that function as tension plates 345 but may not form solid plates. Each tension plate 345 may be fastened to a hydraulic cylinder 350 with a circular mounting bracket 355.

The hydraulic cylinders 350 may be attached to a shaft 360 that is designed to support the weight applied to the sheave from the coiled tubing. The cylinders 350 may be connected to a hydraulic power unit (not shown). Control and/or monitoring may be local to the equipment or remote. The tension plates 345 may have the ability to rotate allowing for combined adjustment near the center of the hub 315 and may be locked at a desired single angle for operation. The tension plates 345 may be coupled to multiple V-rollers 365 near the circumference of the circular member 305. Each V-roller 365 may be secured with a single bolt and allowed to rotate freely.

FIG. 3C shows a partial close-up of FIG. 3B. As shown in FIG. 3C, the V-rollers 365 may have a V-shaped profile 370. The circular member 305 may have a corresponding V-shaped profile 375. The V-shaped profiles 370 and 375 may cooperate to apply a friction bite to tubing 380 interposed between the V-rollers 365 and the circular member 305. Gripping forces may be applied at contact points 371, 372, 373 and 374. There may be grooves contained with the V groove to provide a channel to collect debris without losing the ability of gripping force, as show in FIG. 3D, for example. In certain exemplary embodiments, the V-shaped profiles 370 and 375 may each be adapted to have faces at 120-degree angles, or at other angles. The V-shaped profiles 370 and 375 may be adapted accommodate any range of sizes of tubing 380. In alternative embodiments, the rollers and/or grooves in the circular member may have profiles in any of a variety of shapes.

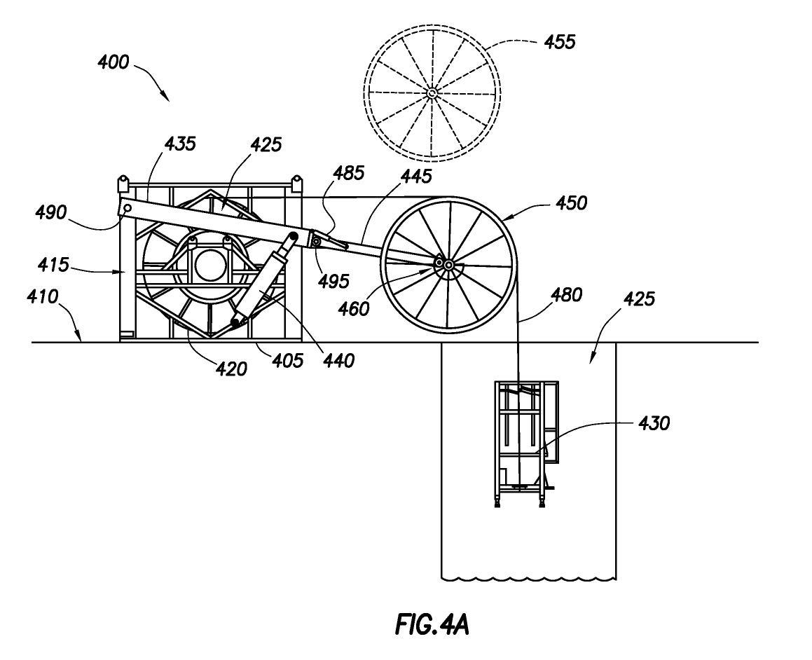

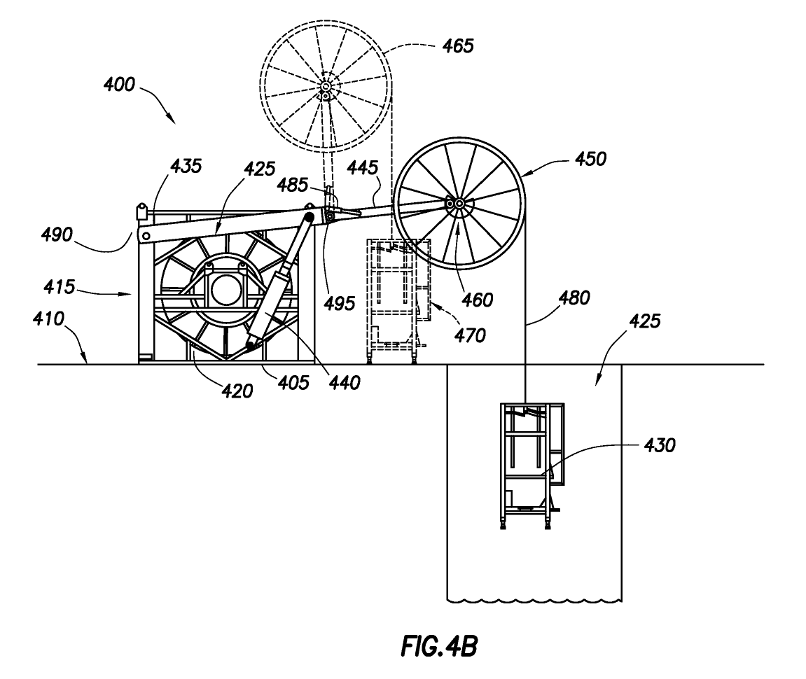

FIGS. 4A and 4B show a schematic of a side view of a coiled tubing system 400. The tubing system 400 may provide a means to deploy coiled tubing from a vessel 410 and may support the weight of the tubing 480 that extends toward the seafloor. In certain embodiments, the tubing system 400 may also support the weight of the subsea injector 430 and/or other equipment/elements. The tubing system 400 may include a coiled tubing reel assembly 420. FIGS. 4A and 4B depict a subsea injector 430 suspended in a moonpool 425. The subsea injector 430 may be configured to feed and direct the coiled tubing 480 from the coiled tubing reel assembly 420 downwardly through the moonpool 425 toward a wellbore, once the injector 430 is positioned on the seafloor.

The coiled tubing reel assembly 420 may include a coiled tubing spool 425 supported on a coiled tubing skid 405 via a reel assembly frame 415. One or more mast booms 435 may be coupled to the reel assembly frame 415 or to some other fixed structure. The mast booms 435 may include or be coupled to a member 445 configured to support a sheave 450 with a tension apparatus, such as tension apparatus 340, as well as any forces bearing on the sheave 450 due to the coiled tubing 480. The mast booms 435 may have one or more hydraulic cylinders 440 attached at points on the mast booms 435 and reel assembly frame 415 that allow for the maximum stroke of the cylinders 440, depending on the location of the pivot point 490. Accordingly, the deployment system 400 may be configured to move sheave 450 through a range of positions. For example, the sheave 400 may be adjusted to a position 455 shown in silhouette in FIG. 4A.

Additionally, a hydraulic cylinder 485 may be attached to the main boom 435 and the mast boom 445 to provide the actuating means of moving the mast boom 445 relative to main boom 435 about pivot point 495. As depicted in FIG. 4B, the sheave 450 may be rotated about the pivot point 495. By way of rotating the member 445 with the hydraulic cylinder 485 and retrieving/feeding tubing 480 with the coiled tubing reel assembly 420, the subsea injector 430 may be lowered onto the deck of the vessel 410. Such an operation may be reversed to deploy the subsea injector 430 may be lowered from the deck of the vessel 410.

The coiled tubing system 400 may be configured to compensate for the heave of the sea. During a period when the tubing 480 is not being dispensed from the reel assembly 420, the tension apparatus such as tensioner 340 may apply a frictional bite such that the tubing 480 is stationary relative to the sheave 450. Rotation of sheave 450 relative to member 445 may be minimized or prohibited by motor 460. During a period when the heave of the sea falls, thereby lowering the vessel 410, one or more of cylinders 440, cylinder 485 and motor 460 may provide the actuating means for raising sheave 450, and thereby tubing 480, to compensate for the decreasing elevation of the vessel 410. Conversely, during a period when the heave of the sea rises, thereby raising the vessel 410, one or more of cylinders 440, cylinder 485 and motor 460 may provide the actuating/releasing means for lowering sheave 450, and thereby tubing 480, to compensate for the increasing elevation of the vessel 410. Accordingly, certain embodiments may utilize a single actuating/releasing means for compensation; other embodiments may utilize a plurality of actuating/releasing means.

The actuating/releasing means may be passive. Passive compensation may include the configuring of one or more of cylinders 440 and cylinder 485 to apply an upwardly directed force component on the tubing 480. The upwardly directed force component may be less than the opposing downwardly directed force component applied via the tubing 480 and may be sufficient to maintain tension on tubing 480 while allowing the tubing 480 to remain stationary. Accordingly, the one or more cylinders may allow sheave 450 to move with the heave of the sea and to maintain tension on tubing 480.

The actuating/releasing means may be active. Active compensation may include a control system that includes a controller, one or more input parameters, one or more output parameters, and one or more sensors configured to provide signals relating to the one or more input parameters. The control system may take into account one or more of an elevation of the vessel 410, the position of the sheave 450, and the tension of the tubing 480. The control system may utilize one or more of a processor(s), a feedback control loop, a feed forward control function, a sensor inaccuracy compensation function, and a noise reduction function. The control system may dynamically adjust one or more of cylinders 440, cylinder 485, and motor 460 to allow sheave 450 to move with the heave of the sea, thereby maintaining tension on the tubing 480 and allowing the tubing 480 to remain stationary.

The tubing system 400 may be adapted to deploy any conduit that could be used in an underwater installation, such as pipelines and subsurface trees, as a means of establishing communication. The tubing system 400 may allow for a single down line to be deployed and retrieved. The addition of electrical conductors to the conduit, e.g., E-line coil tubing, and a surface electric slip-ring can allow for monitoring of one or more various sensors disposed subsea, as desired.

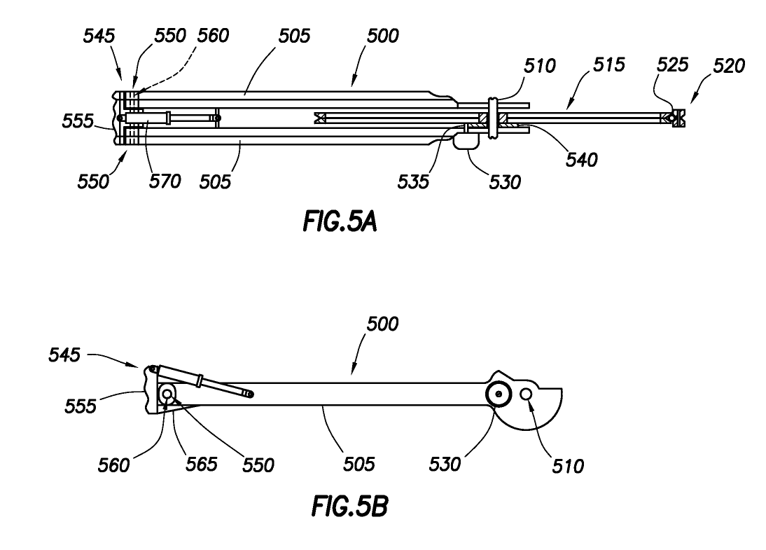

FIGS. 5A and 5B respectively show partial cross-sectional top and side views of a mast boom 500 according to certain embodiments of the present disclosure. The mast boom 500 may include one or more beam members 505. In embodiments with two beam members 505, the beam members 505 may be coupled together. The beam members 505 may be coupled to a shaft 510 and may cooperate to support sheave 515, including tension apparatus 520 and a weight applied via tubing 525. A power unit 530, configured to drive the sheave 515, may include a motor mounted to a beam member 505. A drive gear 535 may mate with a gear 540 on the sheave 515. An end 545 generally opposite of the sheave 515 may include eyes 550 that allow the mast boom 500 to be attached to the main boom 555 via a pin connection 560. The connection 560 may be adapted to allow the mast boom 500 to rotate with respect to main boom 555. A bottom support plate 565 may be attached to main boom 555 and may be adapted to support the mast boom 500 at any desired angle with respect to the main boom 555. As shown in FIG. 5B, the bottom support plate 565 may be adapted to support the mast boom 500 when it is longitudinally aligned with main boom 555.

Accordingly, certain embodiments of the present disclosure provide for a sheave apparatus and coiled tubing system that may provide a means to deploy coil tubing from a vessel and that may support the weight of the pipe that is suspended in the water. Certain embodiments provide for a sheave apparatus and coiled tubing system that may allow the coil tubing to change orientation through a variety of angles, such as changing from a horizontal position to vertical position. Certain embodiments provide a means for creating a friction bite about the exterior of tubing or piping. A tension plate, coupled to a shaft of the sheave assembly with the use of hydraulic cylinders, may transfer force for creating the friction bite. V-rollers may be positioned along the circumference of a tension plate to apply force to the pipe. With this friction bite, a controlled force may be applied to the pipe, thereby allowing the pipe to be deployed through a column of water safely. Certain embodiments may utilize a main boom to lift a subsea injector from a deck of a vessel and position it over a moonpool in a safe manner. Once the injector has reached the sea floor and has been attached to a subsea assembly, the main boom, by way of hydraulic cylinders, may act as a compensation device when tubing is stationary in the injector.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee.

What is claimed is:

1. A tubing sheave apparatus comprising:
a circular member having a grooved circumference;
a hub coupled to the circular member via one or more radial support members, wherein the circular member and the hub have a rotational axis;
a roller disposed near the grooved circumference; and
an actuator coupled to the roller and configured to move the roller at least toward the grooved circumference;
wherein the roller and the grooved circumference are configured to contact tubing disposed therebetween.

2. The tubing sheave apparatus of claim 1, wherein the grooved circumference comprises an angular profile.

3. The tubing sheave apparatus of claim 1, further comprising:
a motor assembly coupled to the hub and adapted to rotatably drive the hub.

4. The tubing sheave apparatus of claim 1, wherein the roller comprises a groove configured to contact tubing.

5. The tubing sheave apparatus of claim 4, wherein the groove comprises an angular profile.

6. The tubing sheave apparatus of claim 1, further comprising:
an extension member coupled between the actuator and the roller, wherein the extension member is adapted to transfer forces between the actuator and the roller.

7. The tubing sheave apparatus of claim 1, wherein:
the actuator comprises a pair of actuators oppositely disposed relative to the circular member and the hub; and
the rollers comprises a plurality of rollers disposed in tandem.

8. A coiled tubing system comprising:
a sheave adapted for coiled tubing and comprising a grooved rim;
a roller assembly coupled to the sheave and adapted to cooperate with the grooved rim to apply forces to coiled tubing;
a boom section coupled to the sheave;
a reel assembly frame coupled to the boom section;
a reel assembly coupled to the reel assembly frame; and
an actuator coupled between the reel assembly frame and the boom section, wherein the actuator is operable to move the boom section relative to the reel assembly frame;
wherein the boom section and the sheave are configured to cooperatively adjust based on vertical forces applied to the reel assembly frame.

9. The coiled tubing system of claim 8, wherein the mast section further comprises:
a main boom section pivotably coupled to the reel assembly frame;
a mast boom section pivotably coupled to the main boom section and rotatably coupled to the sheave; and
a boom section actuator coupled to the main boom section and the mast boom section, wherein the boom section actuator is operable to move the mast boom section relative to the main boom section.

10. The coiled tubing system of claim 9, further comprising:
a motor assembly coupled to the mast boom section and operable to rotatably drive the sheave.

11. The coiled tubing system of claim 8, wherein the boom section and the sheave are configured to cooperatively maintain substantially constant tension on coiled tubing extending from the reel assembly to the sheave and to an area below the sheave.

12. The coiled tubing system of claim 8, wherein the grooved rim comprises an angular profile.

13. The coiled tubing system of claim 8, wherein the roller assembly comprises one or more rollers disposed near the grooved rim.

14. The coiled tubing system of claim 13, wherein the one or more rollers comprise an angular profile.

15. The coiled tubing system of claim 8, further comprising:
an actuator coupled to the roller assembly and operable to move the roller at least toward the grooved rim.

16. The coiled tubing system of claim 8, further comprising:
coiled tubing extending from the reel assembly to the sheave and to an area below the sheave;
wherein the reel assembly frame, the actuator, the boom section, and the sheave are operable to move equipment coupled to the coiled tubing below the sheave.

17. The coiled tubing system of claim 16, wherein the reel assembly frame is operable to swivel about an axis.

18. The coiled tubing system of claim 17, wherein the reel assembly frame, the actuator, the boom section, and the sheave are operable to move equipment horizontally.

19. A method of deploying coiled tubing from a seagoing vessel, the method comprising:
lowering coiled tubing into a body of water with a coiled tubing system, wherein the coiled tubing system comprises:
a sheave adapted for coiled tubing and comprising a grooved rim;
a roller assembly coupled to the sheave and adapted to cooperate with the grooved rim to apply forces to coiled tubing;
a boom section coupled to the sheave;
a reel assembly frame coupled to the boom section;
a reel assembly coupled to the reel assembly frame; and
an actuator coupled between the reel assembly frame and the boom section, wherein the actuator is operable to move the boom section relative to the reel assembly frame; and
adjusting the boom section and the sheave based on vertical forces applied to the reel assembly frame.

20. The method of claim 19, further comprising:
maintaining substantially constant tension on the coiled tubing extending to an area below the sheave.
